(19) United States
(12) Patent Application Publication
(10) Pub. No.: US 2004/0250105 A1
(43) Pub. Date: Dec. 9, 2004

(54) Method and apparatus for creating an execution shield

(76) Inventor: Ingo Molnar, Gyongyos (HU)

Correspondence Address: STEVEN B. PHILLIPS, MOORE & VAN ALLEN, SUITE 800, 2200 WEST MAIN STREET, DURHAM, NC, 27705, US

(21) Appl. No.: 10/420,253

(22) Filed: Apr. 22, 2003

(51) Int. Cl. G06F 9/00

(52) U.S. Cl. 713/200

(57) ABSTRACT

Method and apparatus for creating an execution shield. The present invention minimizes security exposures resulting from so-called “stack overflows,” “buffer overflows” and pointer overflows by creating an “execution shield” within the virtual memory space of an instruction execution system such as a personal computer or workstation. The execution shield is defined by dynamically setting a code segment limit value, which is continuously reset to take into account execution limits of tasks being executed in the system. Additionally, executable code regions are compressed at low-end addresses of the virtual memory space. When an application tries to execute code outside the shield, which may quite possibly be malicious code designed to grant unauthorized access to the system, the application is shut down. Thus, the operation of the system is secured against the exploitation of overflow conditions.

### CROSS-REFERENCE TO COMPUTER PROGRAM LISTING APPENDIX

A portion of the present disclosure is contained in a compact disc, computer program listing appendix. The compact disc contains an MS-DOS file entitled exec-shield-2-4-20-A3.txt created on the filing date hereof, of approximately 27 kilobytes. The contents of this file are incorporated herein by reference. Any references to “the appendix” or the like in this specification refer to the file contained on the compact disc.

The contents of this file are subject to copyright protection. The copyright owner has no objection to the reproduction by anyone of the patent document or the appendix as it appears in the Patent and Trademark Office patent files or records, but does not waive any other copyright rights by virtue of this patent application.

### BACKGROUND

The wide proliferation of networked computing systems and the use of these resources to manage critical information throughout industry and government have made computer security a key area of technological research and development in recent years. Security vulnerabilities are frequently discovered in new versions of various operating systems, causing software vendors to scramble to release code to patch these security problems. One well-known security vulnerability in some processing platforms has been described as the so-called “buffer overflow,” “pointer overflow” or “stack overflow” security problem.

The stack overflow problem stems from certain aspects of the way random access memory (RAM) is managed in certain processing platforms. Physical RAM in most systems in mapped into larger virtual memory spaces, which are in turn organized in pages, which are in turn defined by pagetables. The memory space stores both executable program code and data. The processor, under the control of the operating system, tracks the locations of executable code, and of the data to be used and manipulated by the executable code. In some platforms, this tracking is accomplished in part through reference to an execution bit in the pagetables. However, in multitasking systems, executable code and data for multiple tasks or programs are stored in the same virtual memory space. Since the data, and to a lesser extent the code, that is being stored and retrieved is constantly changing, an area of memory can sometimes be overwritten by unrelated code without having an immediate effect on a task. This problem is exacerbated in platforms where the processor hardware does not make use of execution bits in the pagetables. It is therefore possible for an attacker to insert malicious code into the virtual memory space, and cause the processor to execute the code. Most often, this malicious code grants the attacker access to the system.

In an attempt to minimize the exploitation of overflows, the processor, in at least some modern processing systems stores a code segment limit, which attempts to place an upper address value limit on where executable code can reside. However, the dynamic nature of a multitasking system causes the problem to remain despite the existence of code segment limits. A more recent, well-known, attempt to minimize the occurrence of security exposures caused by buffer overflows is known as the “non-executable stack patch.” The non-executable stack patch works at least. in part by making an application's memory stack non-executable. While the non-executable stack patch reduces the risk of an overflow condition being used by an attacker, its effect is limited because the code segment limit value in the processor stays the same over time and is not dynamically set to take into account changing execution limits of the various tasks being executed.

### SUMMARY

The present invention minimizes the exposure resulting from stack, buffer, and pointer overflows by creating an “execution shield” within the virtual memory space of an instruction execution system such as a personal computer or workstation. The execution shield is defined by a dynamically changing code segment limit value, which is continuously reset to take into account changing execution limits of tasks being executed in the system. Additionally, to increase efficiency and enhance the effect of the execution shield, executable code regions are compressed at the low-end addresses of the virtual memory space. Thus, the address limit which defines the execution shield will include, for the most part, only executable regions, not unrelated data regions. Thus, most problems resulting from the exploitation of overflow conditions are eliminated or at least substantially reduced.

According to some embodiments of the invention, an operating system secures the operation of a processing platform by allocating a plurality of virtual memory regions associated with a plurality of tasks, to a plurality of address spaces having substantially the lowest possible addresses. Further, an execution limit for each of the plurality of tasks is tracked, wherein the execution limit corresponds to a highest executable virtual memory address for a task. The code segment limit value in the processor is set to be substantially equal to the execution limit for the current task. Finally, the transfer of execution control to any code positioned at a virtual memory address higher than that defined by the code segment limit value will be denied. In some embodiments, an administrator or operator of the system is notified with an appropriate message, and/or the event is logged. Upon a context switch to a new task, the code segment limit value is updated if necessary to take into account the new execution limit value.

In some embodiments, code segment limit values are cached as a descriptor. For efficiency, the descriptor may be reformatted into a six-byte format. In certain embodiments, the virtual memory space is implemented as a 3 GB space using machine readable memory adapted to work with an Intel™ compatible processor.

In example embodiments of the invention, computer program code that implements an operating system is used to implement aspects of the invention. This code can be stored on a medium. The medium can be magnetic, such as a diskette, tape, or fixed disk, or optical, such as a CD-ROM or DVD ROM. The computer program code can be stored in a semiconductor device. Additionally, the computer program code can be supplied via the Internet or some other type of network. A workstation or computer system typically runs the code as part of an operating system. The computer system can also be called a “program execution system” or “instruction execution system”. The computer program code in combination with the computer system forms the means to execute the invention.

### BRIEF DESCRIPTION OF THE DRAWINGS

FIG. 1 is a conceptual diagram illustrating a virtual memory space for an Intel compatible processor without employing the invention or before the invention has reallocated memory regions to address spaces within the execution shield.

FIG. 2 is a conceptual diagram similar to that illustrated in FIG. 1, however, FIG. 2 shows the virtual memory space after the invention has reallocated memory regions.

FIG. 3 is a flow chart style diagram that illustrates a portion of the memory allocation process of embodiments of the invention.

FIG. 4 is a flow chart which illustrates a portion of the process for setting the code segment limit value in accordance with embodiments off the invention.

FIG. 5 is an additional flow chart which illustrates fault processing when execution of code outside the execution shield is denied according to some embodiments of the invention.

FIG. 6 is a flowchart which illustrates the resetting of the code segment limit at a context switch according to some embodiments of the invention.

FIG. 7 is a block diagram of an instruction execution system, workstation, or computer, which is implementing an embodiment of the invention.

### DETAILED DESCRIPTION OF ONE OR MORE EMBODIMENTS

The present invention is typically embodied in computer software or a computer program product. The embodiments of the present invention described are implemented in a computing platform using the computer operating system commonly known as “Linux” that is available as open source directly over the Internet. The examples presented also apply to computing platforms based on Intel compatible processors. There are numerous sources for Intel based computing systems. Also, Linux is available through various vendors who provide service and support for the Linux operating system. Among these vendors is Red Hat, Inc., of Raleigh, N.C., U.S.A. An example of computer program code in differential patch format that implements the invention is included in the appendix, and its use will be discussed later. The source code example will be readily understood by those of ordinary skill in the art. It will also be understood that this Linux example is shown for illustrative purposes only, in order to provide an example embodiment of the invention. The inventive concept described herein can be adapted to any computer platform using any operating system, including those based on Macintosh™, Unix™, and Windows™.

The meaning of certain terms as used in the context of this disclosure should be understood as follows. The term “execution limit” and similar terms are, in at least most cases, intended to apply to limits that apply to specific processes or tasks that are stored within memory. By contrast, the term “code segment limit” is usually meant to apply to the single address limit enforced by the processor under the control of the operating system. According to the invention, this limit is dynamically updated to implement what is referred to herein as an “execution shield” outside of which code will not be executed. Any of the foregoing terms can be modified by the use of the word “value” to indicate the actual address value which is stored. The word “task” and its various forms are used in the conventional sense with respect to multi-tasking operating systems. The central processor of a computing platform or instruction execution system can be called the “processor,” the “central processing unit” or simply, the “CPU.” Words such as “process” and “program” can be used interchangeably with the word task. A portion of memory allocated to store code related to a task can be referred to as a “virtual memory region,” “virtual memory area,” or an “address space.” In general, the latter term is used to refer to memory regions which have been reallocated through application of the inventive processes described herein. The entire, available, virtual memory (3 GB in Intel systems running Linux) is referred to herein as the “virtual memory space.” At certain places in this disclosure, the word “substantially” is used. This word should be taken in context, and generally means that the process or step is accomplished to the extent necessary to achieve the useful goals envisioned by the invention. Note also that the terms “buffer overflow,” “stack overflow” and “pointer overflow” are used interchangeably herein.

As previously discussed, use of the invention reduces the impact of buffer overflow, pointer overflow, or stack overflow security problems. In the disclosed embodiments, the feature is fully implemented in the operating system kernel, and is fully transparent to applications. The feature works by tracking virtual memory ranges defined by applications to be executable, and causing the kernel scheduler to modify newly executed task code segment limit descriptor values. The code segment limit is a hardware feature of Intel compatible processors wherein a virtual memory address limit is defined. The invention makes use of this limit to implement a dynamic, closely managed execution shield by constantly re-mapping executable virtual memory spaces to low addresses, and dynamically varying the code segment limit to account for each task as it is being executed.

The invention also relocates executable virtual memory regions which are normally scattered throughout the virtual memory space, to address spaces which have substantially the lowest possible addresses. The invention then, in effect, sets up a dynamic execution shield, which takes into account the execution limits of specific tasks. Executable code is stored in address spaces which are all within the execution shield and are all grouped together. This technique has the effect of preventing malicious code, which has overwritten data or unused regions, from being executed. Such code is typically used to trick an application into executing processes that would grant an attacker access to the system. The practical effect is that the malicious code is outside the execution shield, and any transfer of execution to such code positioned there will result in the application being shut down by the operation system kernel. The operating system may also log the event, and/or report the event to a user or system administrator.

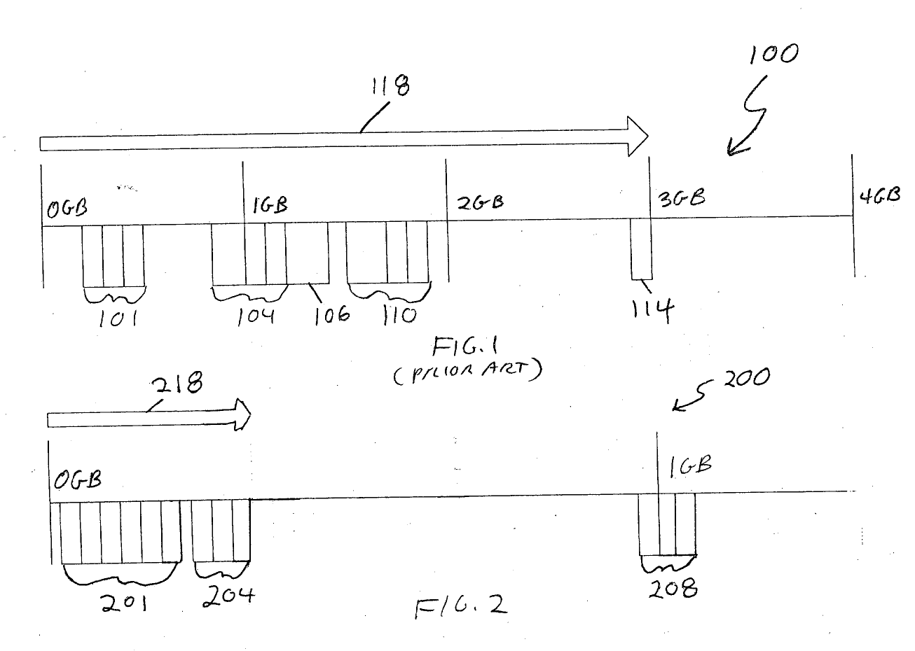

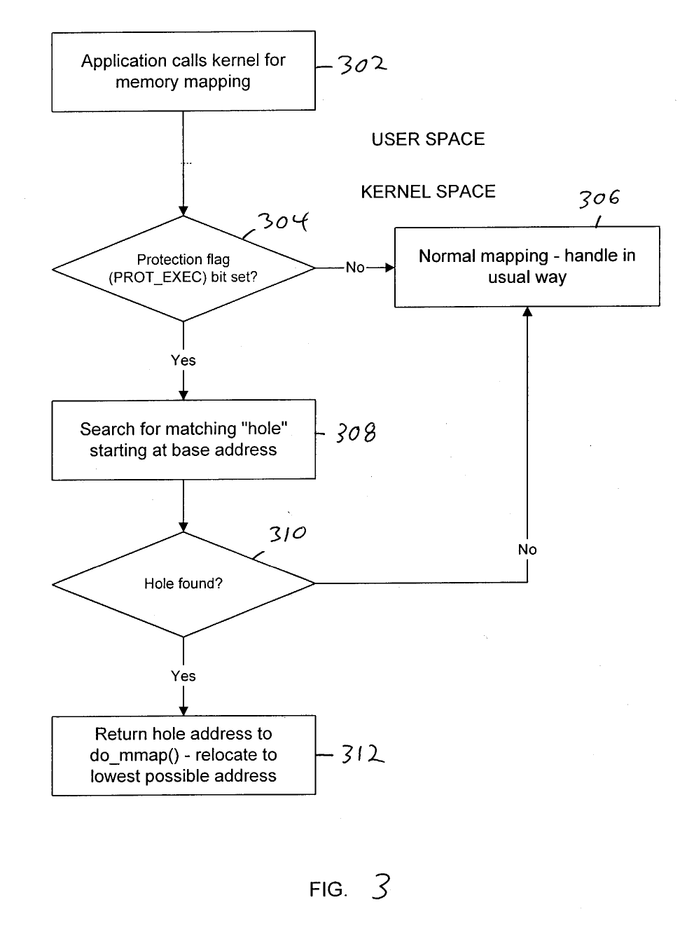

FIGS. 1 and 2 illustrate the effect of the invention on an address space in one embodiment. FIG. 1 is a conceptual diagram showing a virtual memory space without the invention having been applied. The illustration shows a typical, Linux ELF binary memory map layout, 100. The application is the well-known “cat” application, and FIG. 1 is the stock layout for that application. The “cat” application is a simple application that displays all contents of a text file on the terminal. The executable address space, 118, is the entire 3 GB of the virtual memory space which is allocated with a typical, Intel compatible system. Each vertical rectangle that is pictured within the address space corresponds to a range, which defines a virtual memory region. These regions with their address ranges and details about them are listed in the table below with their corresponding drawing reference numbers in the left-most column. Some regions are specifically for code, data, or are designated as “BSS.” Although “BSS” originally meant “block started by symbol,” in modern systems the term is used for zero-initialized global data segments within the virtual memory space. Note that the virtual memory regions on which the invention mostly operates are the code regions.

| | | | | |
|---|---|---|---|---|
| 101 | 08048000-0804c000 | r-x | /bin/cat | code |
| | 0804c000-0804d000 | rw- | /bin/cat | data |
| | 0804d000-0804e000 | rwx | | bss |
| 104 | 40000000-40015000 | r-x | /lib/ld-2.3.2.so | code |
| | 40015000-40016000 | rw- | /lib/ld-2.3.1.so | data |
| | 40016000-40017000 | rw- | | bss |
| 106 | 40017000-40217000 | r-- | /usr/lib/locale/locale- | |
| | | | archive | |
| 110 | 42000000-4212e000 | r-x | /lib/tls/libc-2.3.1.so | |
| | 4212e000-42131000 | rw- | /lib/tls/libc-2.3.1.so | |
| | 42131000-42133000 | rw- | | |
| 114 | bfffe000-c0000000 | rwx | | |

FIG. 2 shows how the addresses and permissions are modified according to the invention. Only the first 1 GB of the virtual memory space, 200, is shown for clarity. The final block remains at the same address as that illustrated in FIG. 1 but loses its execution bit, and is disposed at approximately the 3 GB limit. (It is shown in the table below, just not on the drawing.) Note that substantially all of the executable code is located in address spaces in the substantially lowest address portion of the first 1 GB of the memory space, as indicated by arrow 218. The table below shows how the addresses and permissions have been modified to create new address spaces for executable code.

| | | | |
|---|---|---|---|
| 201 | 00100000-00101000 | r-x | |
| | 00101000-00116000 | r-x | /lib/ld-2.3.1.so |
| | 00116000-00117000 | rw- | /lib/ld-2.3.1.so |
| | 00117000-00245000 | r-x | /lib/tls/libc-2.3.1.so |
| | 00245000-00248000 | rw- | /lib/tls/libc-2.3.1.so |
| | 00248000-0024a000 | rw- | |
| 204 | 01000000-01004000 | r-x | cat-lowaddr |
| | 01004000-01005000 | rw- | cat-lowaddr |
| | 01005000-01006000 | rw- | |
| 208 | 40000000-40001000 | rw- | |
| | 40016000-40017000 | rw- | |
| | 40017000-40217000 | r-- | /usr/lib/locale/locale-archive |
| none | bfffc000-c0000000 | rw- | |

The hexadecimal ranges illustrate the mapping. Every address in the range of arrow 218 is valid and can be used by the application. Addresses outside of the range, for example, address 0x88887777, will fall outside of the execution shield and will be invalid. An attempt to execute code at any of the addresses outside of the execution shield will cause an exception and shut down the application which is attempting to execute the code. In one embodiment, the exception will be reported as a segmentation fault and will result in a so-called “core dump.” Note that the number of entries in the memory map need not stay the same, as the kernel is free to merge or split memory regions as needed, but the total size of the entries stays the same. Note also that the permission bits of the application stack at address bfffc000-c0000000 have changed to make it non-executable, another effect of the application of the execution shield.

Note that permission values are indicated above by three character “rwx” fields. In many operating systems, most notably Unix, r designates a permission to read, w designates permission to write, and x designates a permission to execute a resource, or in this case, a range of addresses. Note that in most Intel compatible systems, the x permission bit is actually merged with the r read bit since Intel systems only support read and write bits, thus these fields in this example such as this are to some extent conceptual in nature.

The effects of the application of the execution shield to the virtual memory space illustrated in FIGS. 1 and 2 are readily visible in the figures. A number of mappings have been moved to low addresses. In fact, all ranges with an x in their permission indicators above are now below the virtual memory address of 16 megabytes. (The drawing is conceptual and does not show address ranges exactly to scale.) Also, for this task, the code segment limit value is set to only allow execution in a shield, which is defined by the address 0x01004000. Thus, protection from the exploitation of stack overflows is substantially enhanced.

It should be noted that due to the permission limitations in Intel x86 processors discussed above, some ranges that are indicated by an rw- are still executable. For example, address 0x00245000 in the example above is outside the shield and is executable. Given that the x bit is not implemented in the processor pagetables, this is the best that can be done with the Intel architecture, but even this level of protection is substantial and will prevent attacks for most purposes. A skilled observer might ask why some of these ranges, for example, the range 00245000-00248000, were left in the shield, given the above problem. The reason is to maintain flexibility to move code, given that related code, data and bss sections must remain together in the case of an ELF binary format application.

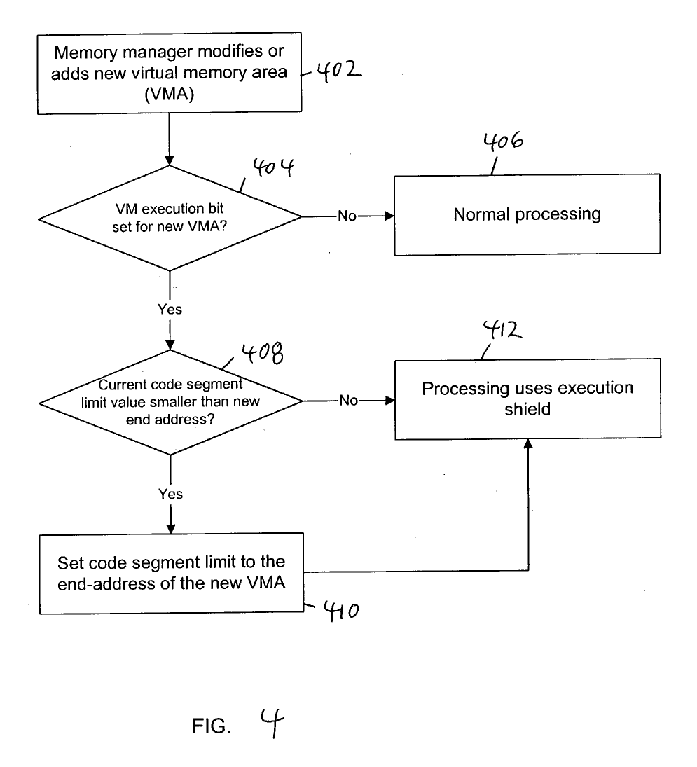

FIGS. 3-6 are flowchart style diagrams that illustrate some of the processes according to example embodiments of the invention. Initially, the operating system kernel can flush the system by clearing all memory mappings and setting the execution shield limit value to zero. Turning to FIG. 3, the processes of the invention are initiated when an application calls the kernel to do a memory mapping, as shown at step 302. Note that the application is running in user space at this point. Once this call is made, processing turns to the kernel, and thus to kernel space. A check of whether the protection flag is set is made at step 304. In Linux systems, this bit is designated PROT_EXEC. If the bit is not set, the areas to be mapped are data areas and not executable areas. Thus, mapping is handled in the same way as it was handled in the prior art at step 306. However, if the protection flag is set, mapping begins according to the invention at step 308. The operating system kernel concurrently tracks execution limits for each task. In FIG. 3, at step 308, the kernel begins allocating a plurality of virtual memory regions associated with the various tasks to address spaces by first searching for a hole which has a matching, starting base address relative to a memory region used by the task. A hole is a range within the virtual memory space that has no active mappings to either data or executable code. If no holes are found, mapping initially proceeds in the normal way at 306. If a hole is found at step 310, however, the hole address is returned to a routine which actually performs the relocation of executables to lower address spaces, at step 312. This routine, known as do_mmap( ), calls an unmapped area function to acquire proper addresses in which to set up address spaces. Step 306 would only be performed in the rare case in which a normal mapping without making use of the mapping portion of the invention would result in all of the executable address spaces having the lowest possible addresses. The do_mmap( ) function is used in the attached source code.

Note that with Linux, most virtual memory allocations are ‘location-independent’ in that the operating system is free to search for any free space it can find in whatever way is appropriate under the circumstances. In a Linux embodiment of the invention, this location independence is used to compress executable regions to lower addresses as has been heretofore described. In order to do this, the operating system kernel must “know” where the holes are, as shown and described relative to the method illustrated in FIG. 3.

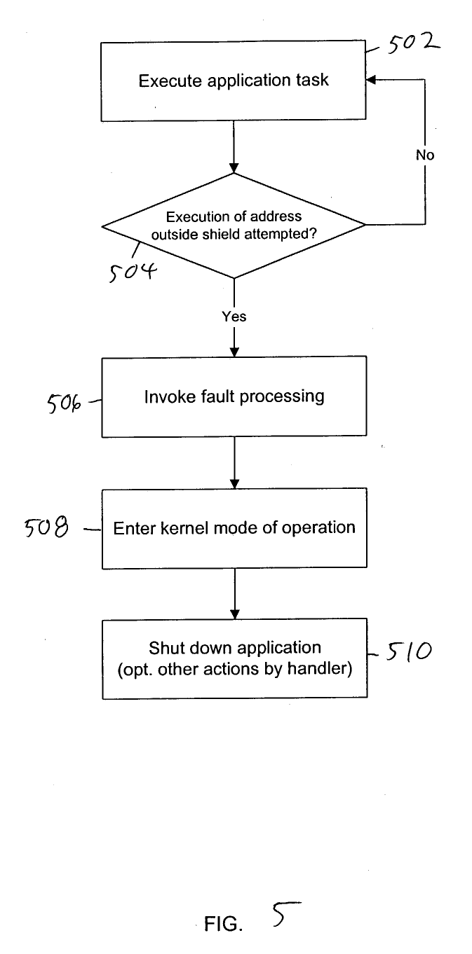

FIG. 4 illustrates the process of tracking execution limits for tasks and setting the code segment limit value to be substantially equal to the highest memory address for the task currently running. At step 402 the memory manager of the operating system modifies or adds a new virtual memory area. The virtual memory area would normally be mapped to a virtual memory region which may or may not be in a low address space. However, due to the memory mapping being conducted in parallel with the dynamic setting of the code segment limit value, the virtual memory area is mapped to an address space having substantially the lowest possible address. At step 404, the virtual memory execution bit is checked to see if it is set for the new virtual memory area. If it is not set, normal processing is conducted at step 406. The virtual memory execution bit is only set when the new virtual memory area is for executable code and therefore there is an execution limit associated with the code, in a similar fashion to the protection flag previously discussed. If the bit is set at step 404, a check is made at step 408 as to whether the current code segment limit is smaller than the end address for the new virtual memory area. This end address corresponds to the execution limit for the current task. If the code segment limit value is appropriate, processing continues making use of the execution shield at step 412. However, if the code segment limit must be reset, it is reset at step 410. In this case, processing continues using the execution shield at step 412, but after the code segment limit value has been reset.

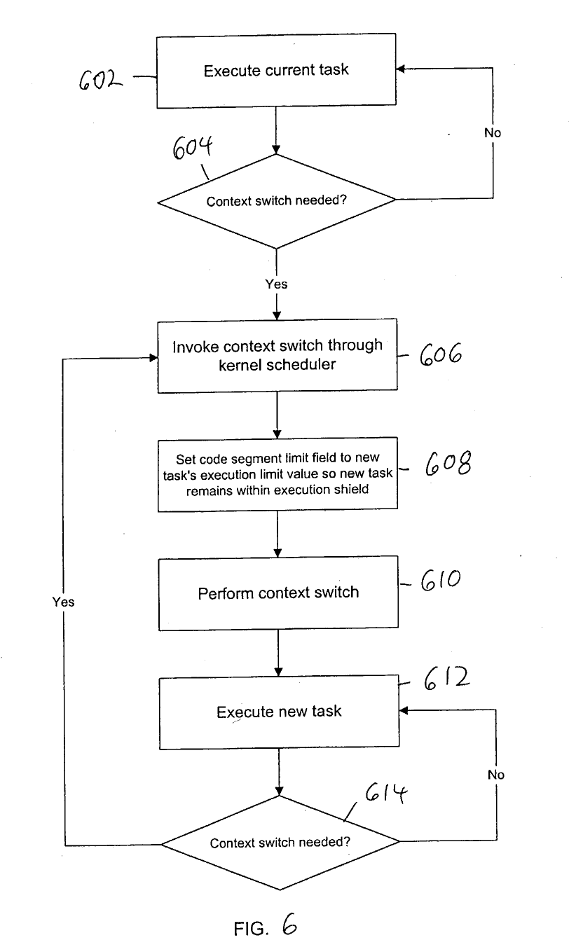

FIG. 5 illustrates fault processing according to the invention. A task or application is executing at step 502. If the task attempts to transfer execution to an address outside of the execution shield, at step 504, fault processing is invoked at step 506. Otherwise, the task continues to execute at step 502. Once fault processing is invoked at step 506, processing enters the kernel at step 508. Transfer of execution control to the code positioned at the virtual memory address higher than that the highest address in the execution shield is denied. In example embodiments, this is accomplished in part through the use of a preset handler at step 510. This preset handler may include logging, and/or operator or administrator notification. Regardless of what other operations are performed, or even whether a specific preset handler is used as opposed to keeping all the processing within the kernel itself, the offending application is shut down at step 512.

There are varying possibilities for the fault handling that can be implemented according to embodiments of the invention. With Intel-based CPU systems, the so-called “general protection fault handler” might be called. Whenever this handler is called, the operating system kernel saves the state of all registers and the state of the application so that it can be restored if the error is recoverable. The handler then interprets the kind of exception/fault that occurred, and then decides whether to abort the application depending on the circumstances. If this handler is used by the execution shield invention described herein, the fault is not recoverable—the application is killed and the parent process of the application is notified. In the case of the Linux code example included in the Appendix, the notification is via a segmentation fault signal, designated SIGSEGV. The parent process programmatically notices this signal. The parent process will typically be a shell. Once the shell receives the notification, it determines what happens, that is, whether the application should quietly disappear, whether the event is logged, and/or whether the user or operator is notified. With systems used in high-security environments, an administrator will usually be notified.

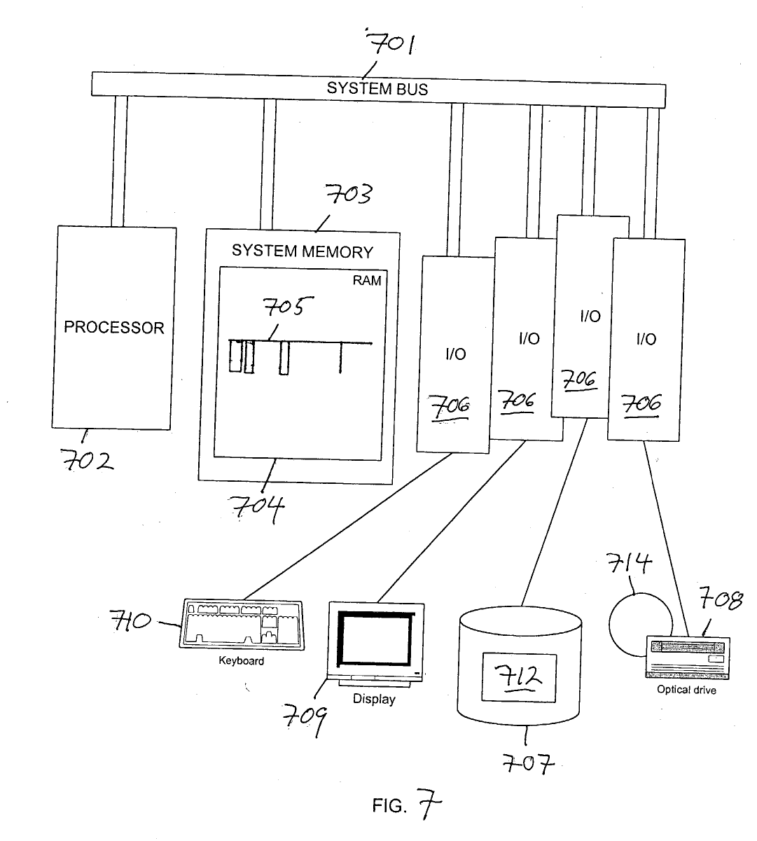

FIG. 6 is a flow chart which indicates how context switches are handled. A current task is executing at step 602. If a context switch is detected at step 604, it is invoked through the operating system kernel scheduler at step 606. At step 608, the current code segment limit field is set to the new task execution limit value so that the new task remains within the execution shield. In this manner, the code segment limit value, and hence the size of the execution shield, is set dynamically, to maintain maximum effectiveness. The context switch is performed at step 610, and the new task begins executing at step 612. If another context switch is invoked at step 614, the process repeats.

With the execution shield feature in the example embodiment shown here, upon a context switch, the feature is practically implemented through the kernel modifying the fourth segment descriptor in the global descriptor table (GDT) of the processor to have a limit field value equal to the highest executable address. The code segment limit value changes as the tasks being executed change. Thus, it dynamically adapts to what the processing platform is doing. The required limit varies depending on the dynamic libraries loaded at any given time and similar factors. Naturally, if multiple threads share the same total virtual memory, then they share the same execution limit as well.

It should be noted, and can be appreciated through study of the computer program code appendix, that a code segment limit for a process is stored in a virtual memory data structure called struct_mm. It can also be appreciated that the value is also cached in the format of a six byte descriptor, which is also stored in the data structure. Upon a context switch, the kernel copies those six bytes onto the code segment descriptor. This caching provides for performance optimization in that a six byte descriptor is more efficient in run time construction.

It should also be understood that the flow charts, which are used to illustrate the inventive concepts, are not mutually exclusive. In many cases, these processes are conducted in parallel. Likewise, the steps in the appended claims are not necessarily conducted in the order recited, and in fact, in many cases two or more of the steps are conducted in parallel.

As previously discussed, in some embodiments, the invention is implemented through a computer program code operating on a programmable computer system or instruction execution system such as a personal computer or work station, or other microprocessor based platform. Thus, the use of the invention acts to secure the operation of such a system against the exploitation of overflows. FIG. 7 illustrates further detail of an instruction execution system that is implementing the invention. The system bus 701 interconnects the major components. The system is controlled by microprocessor 702, which in some embodiments, is an Intel compatible microprocessor. Note that the invention can be applied to other architectures. The system memory, 703, is. typically divided into various regions or types of memory. At least one of those is random access memory (RAM), 704. Since the invention is operating in the system of FIG. 7, the RAM has various virtual memory areas mapped into address spaces in the manner consistent with the invention as described herein. This mapping is conceptually illustrated by memory map 705. A plurality of general input/output (I/O) adaptors or devices, 706, are present. These connect to various peripheral devices including fixed disc drive 707, optical drive 708, display 709, and keyboard 710. One would also typically connect to a network. Computer program code instructions, in some embodiments part of the operating system, implement the functions of the invention and are stored at 712 on fixed disc drive 707. The computer program product which contains the instructions can be supplied on media, for example, medium 714, which is an optical disc. The computer program instructions perform the various operations that implement the invention, including the memory mapping, and the setting of the execution shield limit value. It should be noted that the system of FIG. 7 is meant as an illustrative example only. Numerous types of general-purpose computer systems are available and can be used.

In particular, the invention can be used with any system where the CPU does not make use of the executable bit in its pagetables, whether a workstation or an embedded system. The invention will also work in multiprocessor environments such as in Symmetric Multi-processor (SMP) systems and Non-uniform Memory Architecture (NUMA) systems. The sample embodiment was in fact tested on an SMP system as well. Since an individual process typically only executes on one CPU at a time, each processor maintains its own code segment limit. Therefore it is quite straightforward to adapt the invention to multiprocessor platforms. It is also quite straightforward to adapt the inventive concepts herein to any operating system that runs on a platform based on a CPU like that described above, including versions of Microsoft's Windows™ operating systems.

Elements of the invention may be embodied in hardware or software. For example, in addition to computer program code which implements the invention taking the form of a computer program product on a medium, the computer program code can be stored in an electronic, magnetic, optical, electromagnetic, infrared, or semiconductor device. Additionally, the computer program may be simply a stream of information being retrieved or downloaded through a network such as the Internet.

The appendix to this application includes source code in differential patch format that implements the features described in this specification in order to carry out embodiments of the invention. The source code is intended to patch a version of the Linux operating system, an open source operating system that can be acquired over the Internet, and from companies that provide support for it. The version of the operating system is well-known at the time of filing of this application as “Phoebe” and can be downloaded from, among other places:

http://rawhide.redhat.com/pub/redhat/linux/beta/phoebe/en/os/i386/SRBMS/kernel-2.4.20-2.48.src.rpm

Once this version of the operating system is downloaded, the code from the appendix of this application can be applied by entering the following commands on a Linux system:

rpm -i kernel-2.4.20-2.48.src.rpm

cd /usr/src/redhat/SPECS/

rpmbuild --bp kernel-2.4.spec

cd /usr/src/redhat/BUILD/kernel-2.4.20/linux-2.4.20/

patch -p1</path/to/exec-shield-2.4.20-A3

One of ordinary skill in the art can easily adapt the source code in the appendix of this application to other versions of Linux, and adapt the invention to other operating systems.

Specific embodiments of an invention are described herein. One of ordinary skill in the computing and programming arts will recognize that the invention can be applied in other environments and in other ways. The following claims are in no way intended to limit the scope of the invention to the specific embodiments described above. I claim:

1. A method of securing the operation of an instruction execution system, the method comprising:
allocating a plurality of virtual memory regions, the plurality of virtual memory regions associated with a plurality of tasks, to a plurality of address spaces having substantially the lowest possible addresses;
tracking an execution limit for each of the plurality of tasks, wherein the execution limit corresponds to a highest executable virtual memory address for at least one of the plurality of tasks;
dynamically setting a code segment limit value to be substantially equal to the execution limit for a current task from among the plurality of tasks; and
denying a transfer of execution control to any code positioned at a virtual memory address higher than that defined by the code segment limit value.

2. The method of claim 1 further comprising, upon a context switch to a new task from among the plurality of tasks, setting the code segment limit value to be substantially equal to a new execution limit value associated with the new task.

3. The method of claim 1 wherein the setting of the code segment limit value further comprises reformatting a limit descriptor.

4. The method of claim 2 wherein the setting of the code segment limit value to be substantially equal to the new execution limit value further comprises reformatting a limit descriptor.

5. The method of claim 3 wherein the reformatting of the limit descriptor further comprises reformatting the limit descriptor into a 6-byte descriptor format.

6. The method of claim 4 wherein the reformatting of the limit descriptor further comprises reformatting the limit descriptor into a 6-byte descriptor format.

7. The method of claim 1 wherein the denying of the transfer of execution control further comprises notifying an operator.

8. The method of claim 6 wherein the denying of the transfer of execution control further comprises notifying an operator.

9. Apparatus for establishing an execution shield in an instruction execution system, the apparatus comprising:
means for allocating a plurality of virtual memory regions, the plurality of virtual memory regions associated with a plurality of tasks, to a plurality of address spaces having substantially the lowest possible addresses;
means for tracking an execution limit for each of the plurality of tasks, wherein the execution limit corresponds to a highest executable virtual memory address for at least one of the plurality of tasks;
means for dynamically setting a code segment limit value to be substantially equal to the execution limit for a current task from among the plurality of tasks; and
means for denying a transfer of execution control to any code positioned at a virtual memory address higher than that defined by the code segment limit value.

10. The apparatus of claim 9 further comprising means for reformatting a limit descriptor.

11. The apparatus of claim 10 wherein the means for reformatting of the limit descriptor further comprises means for reformatting the limit descriptor into a 6-byte descriptor format.

12. The apparatus of claim 9 further comprising means for notifying an operator when transfer of execution control is denied.

13. The apparatus of claim 10 further comprising means for notifying an operator when transfer of execution control is denied.

14. The apparatus of claim 11 further comprising means for notifying an operator when transfer of execution control is denied.

15. A computer program product having a computer program embodied therein, the computer program at least in part operable to secure the operation of an instruction execution system, the computer program comprising:
instructions for allocating a plurality of virtual memory regions, the plurality of virtual memory regions associated with a plurality of tasks, to a plurality of address spaces having substantially the lowest possible addresses;
instructions for tracking an execution limit for each of the plurality of tasks, wherein the execution limit corresponds to a highest executable virtual memory address for at least one of the plurality of tasks;
instructions for dynamically setting a code segment limit value to be substantially equal to the execution limit for a current task from among the plurality of tasks; and
instructions for denying a transfer of execution control to any code positioned at a virtual memory address higher than that defined by the code segment limit value.

16. The computer program product of claim 15 wherein the computer program further comprises instructions for reformatting a limit descriptor.

17. The computer program product of claim 16 wherein the instructions for reformatting of the limit descriptor further comprise instructions for reformatting the limit descriptor into a 6-byte descriptor format.

18. The computer program product of claim 15 wherein the computer program further comprises instructions for notifying an operator when transfer of execution control is denied.

19. The computer program product of claim 16 wherein the computer program further comprises instructions for notifying an operator when transfer of execution control is denied.

20. The computer program product of claim 17 wherein the computer program further comprises instructions for notifying an operator when transfer of execution control is denied.

21. An instruction execution system comprising:
an operating system operable to track an execution limit corresponding to a highest executable virtual memory address for each of a plurality of tasks, allocate a plurality of virtual memory regions, and dynamically set a code segment limit value; and
a machine readable memory encoded with at least one data structure further comprising the plurality of virtual memory regions, wherein the plurality of virtual memory regions is associated with the plurality of tasks, and further wherein the plurality of virtual memory regions is allocated to a plurality of address spaces having substantially the lowest possible addresses;
wherein the code segment limit value is dynamically set to be substantially equal to the execution limit for a current one of the plurality of tasks, so that a transfer of execution control to any code positioned at a virtual memory address higher than that defined by the code segment limit value is denied.

22. The instruction execution system of claim 21 wherein the operating system is adapted for an Intel-compatible processor.

23. The instruction execution system of claim 22 wherein the virtual memory regions are allocated within a three gigabyte virtual memory space.

24. The instruction execution system of claim 22 wherein the code segment limit is cached as a six-byte descriptor.

25. The instruction execution system of claim 23 wherein the code segment limit is cached as a six-byte descriptor.
